(19) United States
(12) Patent Application Publication
(10) Pub. No.: US 2023/0387751 A1
(43) Pub. Date: Nov. 30, 2023

(54) Centrifugal Pump With a Drive

(71) Applicant: KSB SE & Co. KGaA, Frankenthal (DE)

(72) Inventor: Axel SCHUNK, Frankenthal (DE)

(21) Appl. No.: 18/031,918

(22) PCT Filed: Oct. 5, 2021
(86) PCT No.: PCT/EP2021/077407

§ 371 Date: Apr. 14, 2023

(30) Foreign Application Priority Data
Oct. 16, 2020 (DE) 10 2020 006 366.7

(51) Int. Cl. H02K 9/06; H02K 5/173; H02K 5/20; H02K 7/08; H02K 11/33

(52) U.S. Cl. CPC H02K 9/06; H02K 5/1732; H02K 5/207; H02K 7/083; H02K 11/33

(57) ABSTRACT

A pump assembly is provided with a coupling unit which connects a pump casing to a motor casing. The motor casing includes at least one cooling body coupled to a fan-side bearing arrangement which supports a bearing supporting a shaft of a rotor of the motor. Preferably the fans-side bearing arrangement and the at least one cooling body are formed integrally, with a portion of the cooling body having passages formed by cooling fins which support a base for motor control electronics. The air flow generated by a fan at the fan-side of the motor at least in part is directed from the region of the fan into the cooling body passages to cool one or moth of the motor electronics and the motor's stator.

### CROSS REFERENCE TO RELATED APPLICATION

This application claims priority under 35 U.S.C. § 119 from German Patent Application No. 102020006366.7, filed Oct. 16, 2020, the entire disclosure of which is herein expressly incorporated by reference.

### BACKGROUND AND SUMMARY OF THE INVENTION

The invention relates to a centrifugal pump with a drive which has a rotor, a stator winding, and a device which comprises a frequency inverter and a cooling body, wherein the drive has a motor housing and a fan, and a shaft is carried by a fan-side bearing arrangement and a pump-side bearing arrangement.

A centrifugal pump arrangement generally comprises one or more centrifugal pumps, one or more electric motors, and electronic equipment for regulating the rotational speed and for inverting the frequency. Especially the electric motors and the associated motor electronics require adequate cooling.

Typical electric motors of this type are generally known. The motor electronics are often provided on the outer wall of the motor. They generally contain a frequency inverter and a power control system and/or a rotational speed regulating system. The motor electronics are often arranged on a base so that the heat discharged by the electric motor does not affect the electronics. However, as a result the cooling air stream of the motor no longer adequately reaches the arrangement of the electronics, as a result of which separate cooling of the electronics is often required.

Both radial and axial designs of such cooling systems for electric motors and frequency inverters are generally known. Described in DE 103 39 585 A1 is an axially generated cooling air stream which is deflected with the aid of air-guidance elements in order to cool the radially constructed terminal box. The air-guidance elements can be arranged variably in order to achieve the goal of sufficient cooling. To do this, a technician is needed to adjust the cooling adequately during operation. Furthermore, this invention is constructed from many individual parts, which increases costs and is complex in terms of mounting.

DE 103 62 051 describes an arrangement of a fan for cooling the motor and a power converter, wherein the fan impeller is driven by the motor shaft. The stream of air thus cools the motor and the electronics uniformly. As a whole, the arrangement consists of a plurality of individual parts such as the stator housing with a B bearing flange, fan impeller, evaluation electronics, brake, and magnetizable plastic wheel, as well as a fan cover. As a result, the construction is very complex in terms of mounting, wherein the focus of the invention is primarily on the determination of the position of the fan impeller.

DE 10 2008 051 650 A1 discloses an invention with common cooling of the motor and the motor electronics, in which the air stream is drawn in through the cooling frame of the electronics cooling system before the fan impeller propels the air stream to cool the motor frame. The focus here is on cooling a very large motor electronics unit which is constructed around the motor both axially and radially.

The object of the invention is to configure a component such that an electric motor and its motor electronics can be cooled simultaneously with a fan. The component should here be able to receive a bearing which supports and holds the motor shaft. This component should consist of as few individual parts as possible and thus simplify mounting. Furthermore, the component should consist of a thermally conductive material and be able to effectively discharge the resulting heat of both the motor and the motor electronics. Moreover, the number of the mechanical interfaces and the seals should be reduced by virtue of the design of the component. Changing replacement parts should be favored by the construction of the component. It should be possible for the device to be implemented simply and cost-effectively.

This object is achieved according to the invention by a centrifugal pump with a drive having the features of claim 1. Preferred variants can be found in the dependent claims, the description, and the drawings.

According to the invention, a fan-side bearing arrangement and/or a pump-side bearing arrangement is connected to the cooling body of the motor electronics, in particular the frequency inverter. These bearing arrangements have the function of a cover of the motor housing and carry the bearings for mounting the shaft which are integrated in form-fitting and/or force-fitting fashion into the bearing carriers. In a variant of the invention, the cooling body can be designed as an electronics housing base. By virtue of the connected construction of the bearing arrangement to the cooling body, the cooling of the electric motor and the motor electronics can advantageously be configured with particularly high effectiveness.

In a particularly advantageous variant of the invention, the fan-side bearing arrangement, for example the fan-side end bearing cover of the motor housing, is connected to the cooling body. The cooling body can form the basis for the arrangement of the motor electronics and can be optimized in its configuration including cooling ribs for discharging the heat of the motor electronics which can comprise a frequency inverter and a power control system and a rotational speed regulating system. The conducting of heat to the cooled upper surfaces is improved by virtue of the connected construction. Moreover, the cooling air stream generated by the fan can, by means of the appropriately arranged cooling channels, discharge the heat of the electric motor and the motor electronics particularly effectively.

In an alternative variant of the invention, the pump-side bearing arrangement in the form of the pump-side bearing cover is connected to the cooling body. In terms of the conducting of heat and the cooling efficiency, this configuration of the construction is no less advantageous and enables, should this appear to be expedient because of the motor geometry, mounting from the fan side of the motor.

According to the invention, the cooling body is designed as integral with the fan-side bearing arrangement. In the configuration as a one-piece cast part, the cooling body with the integrally formed cooling ribs and the fan-side bearing arrangement is particularly efficient in terms of conducting heat. Moreover, the reduction of the parts to be assembled and the sealing surfaces because of the one-piece design makes mounting particularly easy. At the same time, replacement parts can be changed with minimum effort.

The cooling body can be designed as a plate-shaped element which serves as a base for the motor electronics.

In a further variant of the invention, the connection of the cooling body to a motor housing cover is configured in the form of a screwed connection such that mounting requirements based on the motor geometry can be designed in a way that is convenient for mounting.

Particularly advantageous is the electronics housing base, designed as a cooling body, which features surface-enlarging elements for increasing the cooling performance. They are optimized in the form of cooling ribs for heat discharge and designed integrally with the cooling body. The upper surface of the cooling ribs is dimensioned with respect to the expected heat developed by the motor electronics. Moreover, the cooling ribs of the electronics housing are adapted to the shape of the motor housing.

In a preferred variant of the invention, the cooling body with integrally formed cooling ribs comprises additional air baffles in combination with openings which contribute to increasing the cooling air stream and enable highly effective cooling of the motor electronics.

According to the invention, the bearing arrangement, which can be, for example, a fan-side or a pump-side bearing cover of the motor housing, has openings and passages for cables and plugs. In this way, a connection between the motor electronics and the stator winding is produced.

The bearing arrangement according to the invention of the electric drive can in principle be used both for asynchronous motors and for synchronous motors, in particular for synchronous reluctance motors.

The fan of the electric drive advantageously draws an air stream through the center of the perforated fan cover and thus generates a primary cooling air stream which flows over the motor housing and the cooling body of the motor electronics. The construction of the fan cover enables a secondary air stream to be drawn in as a consequence of the primary air stream, as a result of which the cooling power of the motor and the motor electronics can be particularly intensified.

A preferred variant of the invention is represented by the one-piece design of the fan-side motor housing cover with the cooling body. The one-piece bearing arrangement can be produced as a cast part made from a material with high thermal conductivity, in particular from aluminum. Implementing the cooling in the form of a fan in combination with optimized ventilation channels and surface-enlarging cooling ribs with the particularly thermally conductive material aluminum is considered as extremely highly effective.

The construction of the one-piece bearing arrangement with the cooling body advantageously enables the simultaneous cooling of the motor electronics and the electric motor. Previously, two separate cooling systems were often used which can now be reduced to one particularly efficient cooling system.

Further features and advantages of the invention can be found in the description of exemplary embodiments with the aid of drawings and in the drawings themselves, in which:

### BRIEF DESCRIPTION OF THE DRAWINGS

FIG. 1 shows a schematic illustration of a centrifugal pump with a connecting element and an electric drive,

FIG. 2 shows a cross-section of an electric drive of a centrifugal pump in accordance with the present invention,

FIG. 3 shows a bearing arrangement as in FIG. 2 in a perspective side view,

FIG. 4 shows a bearing arrangement as in FIGS. 2-3 in a perspective internal view.

### DETAILED DESCRIPTION

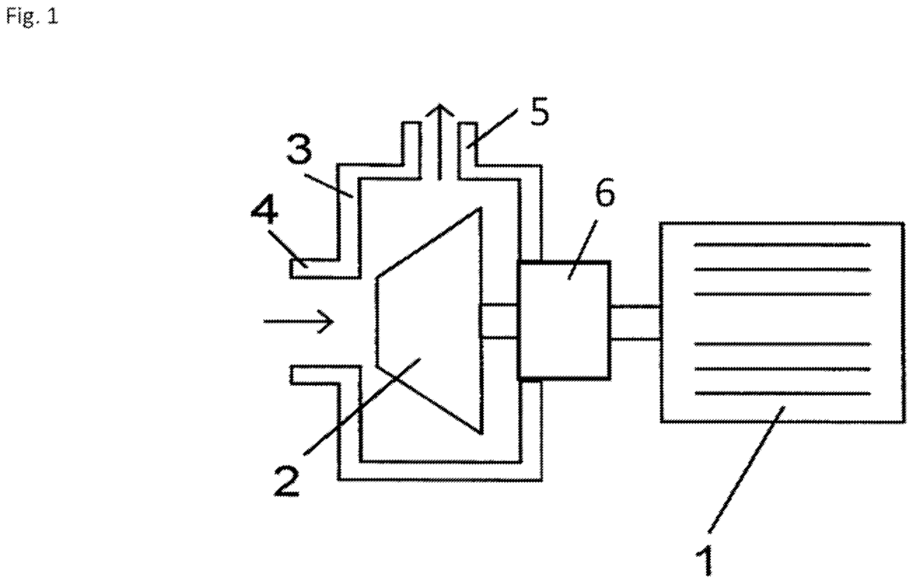

FIG. 1 shows the basic structure of a centrifugal pump which is driven by an electric drive 1 and is equipped with an impeller 2 and a casing 3. The casing 3 has an inlet 4 and an outlet 5. In this exemplary embodiment, a connecting element 6 serves to transmit the driving force delivered by the electric drive 1 to the impeller 2. The fluid enters the pump chamber from the left through the inlet 4 and is fed axially to the impeller 2. The rotating impeller 2 transmits kinetic energy to the fluid which has accumulated in the tapering pressure nozzle and leaves the pump chamber at the top via the outlet 5. The connecting element 6 is representative of all technically known connecting options between the drive 1 and the pump casing.

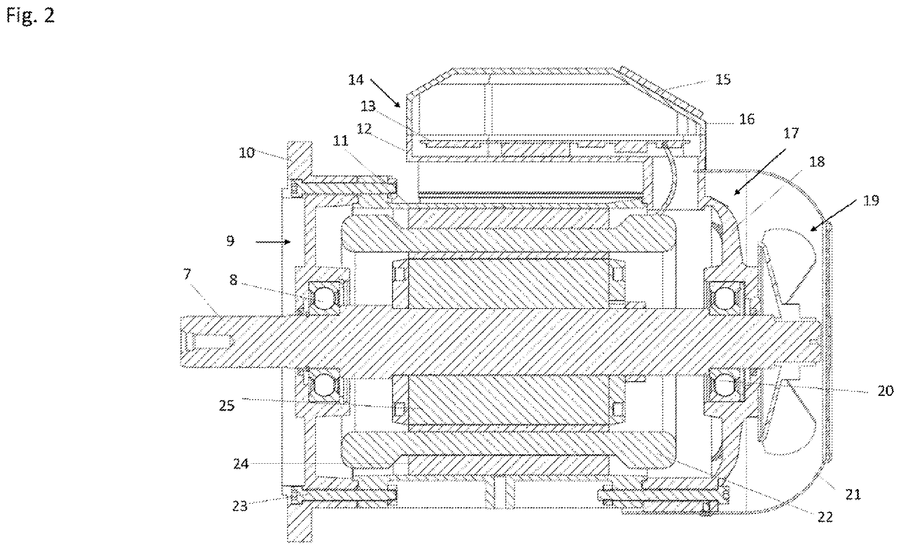

A cross-section of an electric drive 1 of a centrifugal pump is illustrated in FIG. 2. The shaft 7 is supported and mounted by a pump-side bearing arrangement 9 and a fan-side bearing arrangement 17, as a result of which a rotational movement is simultaneously enabled for it. These bearing arrangements 9, 17 comprise a bearing carrier 10, 18 into which a rolling bearing 8, 20 is embedded in form-fitting fashion. At the same time, these bearing arrangements 9, 17 also serve as a cover of the motor housing 11 and thus close the electric drive 1. The shaft 7 has a rotor 25. The circulating magnetic field in the stator winding 22 induces a magnetic field in the opposite direction in the rotor 25 and consequently sets it in motion. The stator winding 22 is fixed by the stator plates 24.

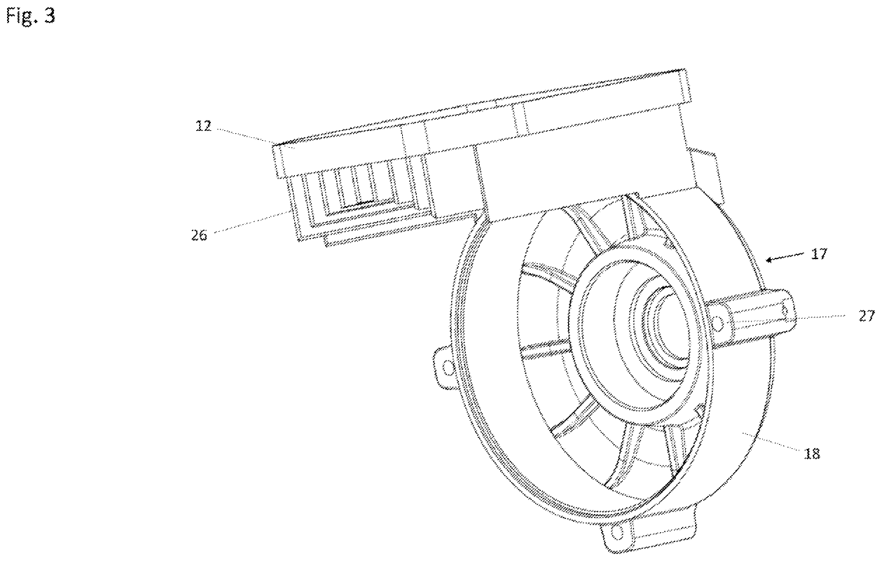

The motor housing 11 closes, together with the pump-side bearing arrangement 9 and the fan-side bearing arrangement 17, the electric drive 1 and at the same time fixes the stator plates 24. The fan impeller 19, which is connected to the shaft 7, is situated outside the rotor/stator space on the fan-side bearing arrangement 17. The fan cover 21 surrounds the space of the fan 19 and thus prevents unprotected access to the possibly rotating fan impeller. The fan 19 draws an air stream through the center of the perforated fan cover 21 and thus generates a primary air stream which, limited by the construction of the fan cover 21 and the bearing arrangement 17, is guided into an annular channel and flows over the motor housing 11 in order to cool it. The fan cover 21 adjoins the bearing arrangement 17 in a manner such that, below the cooling body 12, in particular of the electronics housing base, an opening remains free through which the primary air stream draws a secondary air stream downward with it which in turn intensifies the cooling of the electric drive 1 and the cooling body 12 with its integrally formed cooling ribs 26, wherein the cooling ribs 26 are illustrated in FIG. 3.

In the exemplary embodiment of the invention in FIG. 2, the fan-side bearing arrangement 17 is designed as integral with the cooling body 12. The frequency inverter 13 is arranged and connected in a thermally conductive fashion inside the cooling body 12. The cooling body 12 is closed with an electronics housing cover 16 on which an operating unit 15 for operating the motor electronics 14 is arranged.

FIG. 3 shows the cooling body 12, which is designed in this exemplary embodiment of the invention as integral with the fan-side bearing arrangement 17, in a perspective side view. Surface-enlarging elements 26 in the form of cooling ribs are integrally formed on the cooling body 12 which is configured in the form of an electronics housing base. The configuration of the cooling ribs is adapted to the motor housing 11 (not illustrated in this drawing). The passages 27 serve to connect the motor housing 11 to the bearing carriers 10, 18 with the aid of connecting elements 23 which are preferably configured as screws. The bearing carrier 18 illustrated in FIG. 3 comprises a circular base body, which adjoins a pot-shaped wall on its side for connection to the motor housing.

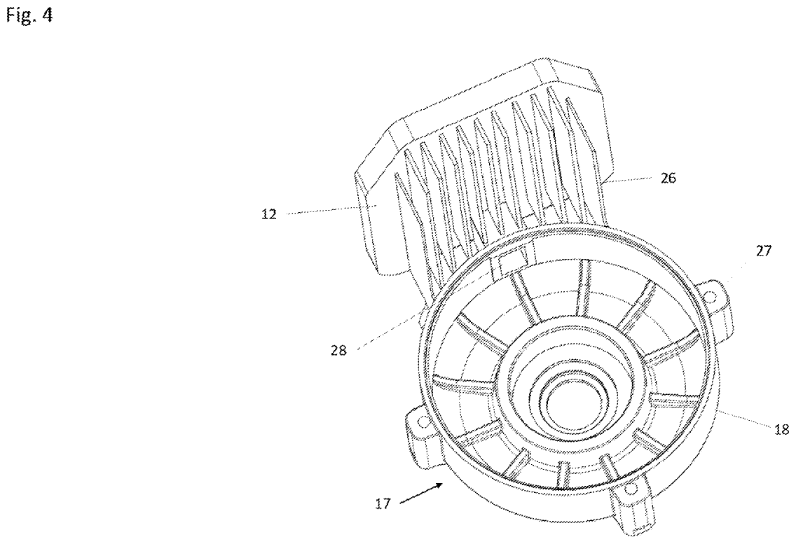

FIG. 4 shows the cooling body 12, which in this exemplary embodiment of the invention is designed as integral with the fan-side bearing arrangement 17, in a perspective internal view. A guide channel 28 is integrated in the transition of the cooling body 12 to the bearing carrier 18 which is configured as the cover of the motor housing 11. As illustrated in FIG. 4, such channels 28 can be configured as rectangular, round and/or square channels also being conceivable, however, and can be implemented in the form of an recess inside a cast part. One or more elements for connection between the frequency inverter 13 and the stator winding 22 are passed through such a channel.

The foregoing disclosure has been set forth merely to illustrate the invention and is not intended to be limiting. Since modifications of the disclosed embodiments incorporating the spirit and substance of the invention may occur to persons skilled in the art, the invention should be construed to include everything within the scope of the appended claims and equivalents thereof.

1-6. (canceled)

7. A centrifugal pump, comprising:
a drive having a rotor, a stator winding, a cooling arrangement which includes a frequency inverter and a cooling body, a motor housing, a fan, a fan-side bearing arrangement configured to support a rotor shaft, and a pump-side bearing arrangement,
wherein the cooling body is connected to one of the fan-side and pump-side bearing arrangements.

8. The centrifugal pump as claimed in claim 7, wherein
the cooling body is connected directly to the one of the fan-side and pump-side bearing arrangements.

9. The centrifugal pump as claimed in claim 8, wherein
the cooling body is integral with the one of the fan-side and pump-side bearing arrangements.

10. The centrifugal pump as claimed in claim 9, wherein
the cooling body has surface-enlarging elements integral with the cooling body.

11. The centrifugal pump as claimed in claim 7, wherein
the bearing arrangement has one or more guide channels configured for passage of a connection between the frequency inverter and the stator winding.

12. The centrifugal pump as claimed in claim 10, wherein
the bearing arrangement has one or more guide channels configured for passage of a connection between the frequency inverter and the stator winding.

13. The centrifugal pump as claimed in claim 7, wherein
the fan is configured to generate:
a central primary air stream, and
a secondary air stream which passes into the cooling body from a region within fan cover over the fan.

14. The centrifugal pump as claimed in claim 12, wherein
the fan is configured to generate:
a central primary air stream, and
a secondary air stream which passes into the cooling body from a region within fan cover over the fan.
